(19) United States
(12) Patent Application Publication
(10) Pub. No.: US 2026/0210648 A1
(43) Pub. Date: Jul. 23, 2026

(54) HEAT EXCHANGER AND AIR CONDITIONER COMPRISING SAME

(71) Applicant: SAMSUNG ELECTRONICS CO., LTD., Suwon-si (KR)

(72) Inventors: Sungtae PARK, Suwon-si (KR); Sangjun PARK, Suwon-si (KR); Won JU, Suwon-si (KR); Youngdeog KOH, Suwon-si (KR); Jungsoo LIM, Suwon-si (KR)

(73) Assignee: SAMSUNG ELECTRONICS CO., LTD., Suwon-si (KR)

(21) Appl. No.: 19/443,791

(22) Filed: Jan. 8, 2026

Related U.S. Application Data
(63) Continuation of application No. PCT/KR2024/007680, filed on Jun. 5, 2024.

(30) Foreign Application Priority Data
Jul. 13, 2023 (KR) 10-2023-0091389

(51) Int. Cl. F28F 21/08; B23K 1/00; B23K 101/14; C22C 21/02; C22C 21/10; F28F 1/12

(52) U.S. Cl. CPC F28F 21/084; B23K 1/0012; C22C 21/02; C22C 21/10; F28F 1/12; B23K 2101/14; F28F 2275/045

(57) ABSTRACT

A heat exchanger comprising a header to supply a refrigerant to a tube through which the refrigerant flows; a heat exchange fin to be coupled to the surface of the tube; and a filler to couple the tube and the heat exchange fin. The header, the tube, the heat exchange fin, and the filler comprise an aluminum alloy, the heat exchange fin comprises a fin core layer and a fin clad layer formed on at least one surface of the fin core layer, the tube has a potential value that is higher than that of the fin core layer by 20 to 250 mV, and the fin core layer has a potential value 20 to 100 mV lower than that of the fin clad layer.

### CROSS-REFERENCE TO RELATED APPLICATION

This application is a continuation application, under 35 U.S.C. § 111 (a), of international application No. PCT/KR2024/007680, filed Jun. 5, 2024, which claims priority under 35 U. S. C. § 119 to Korean Patent Application No. 10-2023-0091389, filed Jul. 13, 2023, the disclosures of which are incorporated herein by reference in their entireties.

### TECHNICAL FIELD

The present disclosure relates to a heat exchanger and an air conditioner including the same.

### BACKGROUND ART

Generally, a heat exchanger is a device that exchanges heat between a refrigerant and outside air by including a tube through which the refrigerant flows and exchanges heat with the outside air, a heat exchange fin that comes into contact with the tube to increase a heat dissipation area, and a header with which opposite ends of the tube communicate. The heat exchanger may include an evaporator or a condenser, and may form a refrigeration cycle device together with a compressor configured to compress refrigerant and an expansion valve configured to expand the refrigerant.

The heat exchanger may be provided with a refrigerant pipe that guides the refrigerant, and the refrigerant pipe may be coupled to a number of heat exchange fins to increase heat exchange efficiency.

A heat exchanger equipped with microchannel tubes as refrigerant pipes is known to have superior heat transfer characteristics compared to other types of heat exchangers, and are used as heat exchangers in air conditioners.

Meanwhile, an aluminum material corresponding to a structural metal is inexpensive and has a lower specific gravity than copper. Further, the aluminum material has excellent processability and thus is widely used in extrusion processes. Recently, the aluminum material has been applied to microchannel tubes in heat exchangers to improve energy efficiency.

Recently, aluminum, which is light and has excellent thermal conductivity, has been used as a material for heat exchanger tubes and heat exchange fins, and research into alloy materials has been actively conducted to secure corrosion resistance properties of aluminum. Further, research has been conducted on organic/inorganic coatings, sacrificial corrosion design of zinc, and sacrificial corrosion design of fins to secure corrosion resistance properties of aluminum.

### DISCLOSURE

### Technical Problem

The present disclosure is directed to providing a heat exchanger capable of inducing selective sacrificial corrosion by adjusting an alloy composition of aluminum forming a tube, a header, and a heat exchange fin based on a difference in each potential value.

Further, the present disclosure is directed to providing a heat exchanger capable of preventing refrigerant leakage from the heat exchanger by sequentially arranging a difference in potential values.

Additional aspects of the disclosure will be set forth in part in the description which follows and, in part, will be obvious from the description, or may be learned by practice of the disclosure.

### Technical Solution

One aspect of the present disclosure provides a heat exchanger including a header configured to supply a refrigerant to tube through which the refrigerant flows; a heat exchange fin to be coupled to a surface of the tube; and a filler to couple the tube and the heat exchange fin. The header, the tube, the heat exchange fin and the filler include an aluminum alloy. A fin clad diffusion layer and a zinc diffusion layer are formed on at least one surface of the tube. The tube has a potential value higher than that of the fin core layer 32 by 20 to 250 mV, and the fin core layer has a potential value lower than that of the fin clad diffusion layer by 20 to 100 mV.

Another aspect of the present disclosure provides an air conditioner including: a compressor; an indoor heat exchanger; an outdoor heat exchanger; and an expansion valve. At least one of the indoor heat exchanger and the outdoor heat exchanger includes: a header configured to supply a refrigerant to tube through which the refrigerant flows; a heat exchange fin to be coupled to a surface of the tube; and a filler to couple the tube and the heat exchange fin. The header, the tube, the heat exchange fin and the filler include an aluminum alloy. A fin clad diffusion layer and a zinc diffusion layer are formed on at least one surface of the tube. The tube has a potential value higher than that of the fin core layer 32 by 20 to 250 mV, and the fin core layer has a potential value lower than that of the fin clad diffusion layer 38 by 20 to 100 mV.

### Advantageous Effects

A potential difference design method of a heat exchanger according to the present disclosure is not limited to a heat exchanger of the above-described type. For example, the potential difference design method according to the present disclosure may also be applied to a folded tube heat exchanger including a rolled tube (outer tube) and folded fin (inner fin) format.

Further, a heat exchanger including a tube having improved corrosion resistance through sacrificial corrosion and an air conditioner including the same may be provided.

The effects obtained from the present disclosure are not limited to the effects mentioned above, and other effects not mentioned will be clearly understood by a person having ordinary skill in the art to which the present disclosure belongs from the description below.

### DESCRIPTION OF DRAWINGS

FIG. 1 is a view illustrating an exterior of an air conditioner according to one embodiment.

FIG. 2 is a view illustrating a configuration related to a flow of a refrigerant in the air conditioner according to one embodiment.

FIG. 3 is a view illustrating an exterior of a heat exchanger according to one embodiment.

FIG. 4 is an exploded perspective view illustrating the heat exchanger according to one embodiment.

FIG. 5 is an enlarged view of a portion A of FIG. 4 according to one embodiment.

FIG. 6 is a view illustrating a tube and a heat exchange fin before and after brazing according to one embodiment.

FIG. 7 is a schematic diagram of an example of the heat exchanger in which the heat exchange fin and the tube are coupled according to one embodiment.

FIG. 8 is a schematic diagram of an example in which a header and the tube are coupled according to one embodiment.

FIG. 9 is a photograph illustrating a cross-section of a state in which the header and the tube are brazed according to one embodiment.

FIG. 10 is a view illustrating heating temperatures over time during brazing according to one embodiment.

FIG. 11 is a photograph illustrating a cross-section of a state in which the tube and the heat exchange fin are brazed according to one embodiment.

FIG. 12 is a photograph illustrating results of the 50th day of CASS test according to the tube material according to one embodiment.

### MODES OF THE INVENTION

In the following description, like reference numerals refer to like elements throughout the specification. Well-known functions or constructions are not described in detail since they would obscure the one or more exemplar embodiments with unnecessary detail. Terms such as “unit”, “module”, “member”, and “block” may be embodied as hardware or software. According to embodiments, a plurality of “unit”, “module”, “member”, and “block” may be implemented as a single component or a single “unit”, “module”, “member”, and “block” may include a plurality of components.

It will be understood that when an element is referred to as being “connected” another element, it can be directly or indirectly connected to the other element, wherein the indirect connection includes “connection via a wireless communication network”.

Also, when a part “includes” or “includes” an element, unless there is a particular description contrary thereto, the part may further include other elements, not excluding the other elements.

Throughout the description, when a member is “on” another member, this includes not only when the member is in contact with the other member, but also when there is another member between the two members.

It will be understood that, although the terms first, second, third, etc., may be used herein to describe various elements, but is should not be limited by these terms. These terms are only used to distinguish one element from another element.

As used herein, the singular forms “a,” “an” and “the” are intended to include the plural forms as well, unless the context clearly indicates otherwise.

An identification code is used for the convenience of the description but is not intended to illustrate the order of each step. The each step may be implemented in the order different from the illustrated order unless the context clearly indicates otherwise.

Hereinafter embodiments of a heat exchanger will be described in detail with reference to the accompanying drawings.

In general, a heat exchanger is a device that exchanges heat between a refrigerant and outside air by including a tube through which the refrigerant flows and exchanges heat with the outside air, a heat exchange fin that comes into contact with the tube to increase a heat dissipation area, and a header with which opposite ends of the tube communicate.

The heat exchanger may be applied in a variety of ways, as long as the heat exchanger transfers heat between high-temperature and low-temperature liquids. For example, the heat exchanger may be used in a variety of applications such as waste heat recovery, cooling of high-temperature fluids, heating of low-temperature fluids, condensation of vapor, and evaporation of low-temperature fluids.

The heat exchanger may be applied to a variety of devices including air conditioners and refrigerators. Before describing the heat exchanger, an application example of the heat exchanger will be described using an air conditioner as an example.

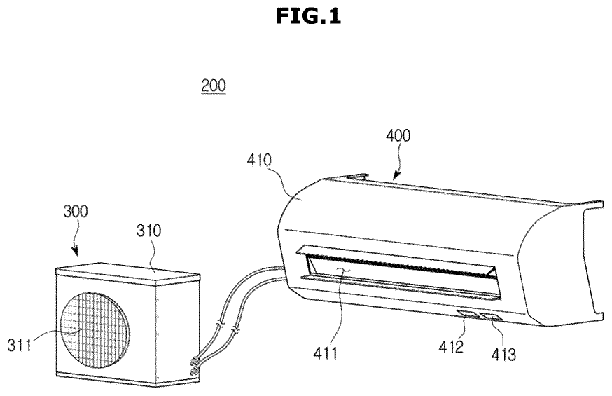

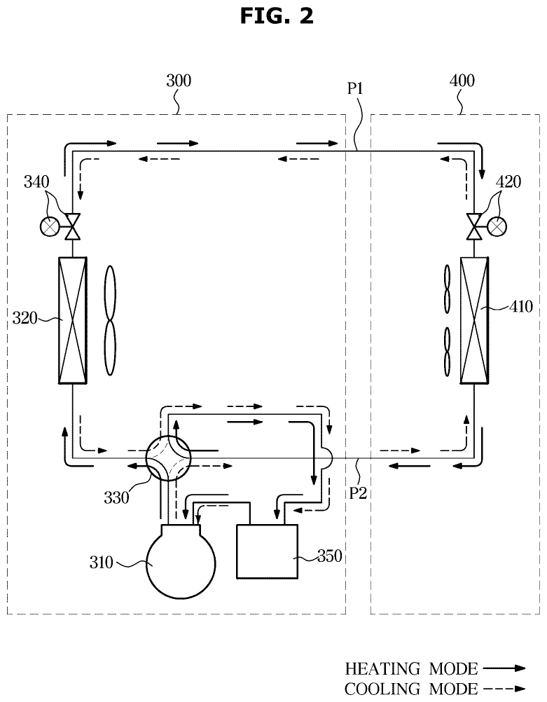

FIG. 1 is a view illustrating an exterior of an air conditioner according to one embodiment. FIG. 2 is a view illustrating a configuration related to a flow of a refrigerant in the air conditioner according to one embodiment.

Referring to FIG. 1, an air conditioner 200 according to one embodiment includes an outdoor unit 300 installed in an outdoor space to perform heat exchange between outdoor air and a refrigerant, and an indoor unit 400 installed in an indoor space to perform heat exchange between indoor air and a refrigerant.

The outdoor unit 300 includes a body 305 forming an exterior of the outdoor unit 300, and an outdoor unit discharge port 311 provided on one side of the outdoor unit body 305 discharging heat-exchanged air.

The indoor unit 400 may include an indoor unit body 405 forming an exterior of the indoor unit 400, an indoor unit discharge port 411 provided on a front surface of the indoor unit body 405 discharging heat-exchanged air, an inputter 412 receiving an operation command for the air conditioner 200 from a user, and a display 413 displaying operation information of the air conditioner 200.

Referring to FIG. 2, in addition to the outdoor unit 300 and the indoor unit 400, the air conditioner 200 according to one embodiment includes a gas pipe P1 that serves as a passage, through which a gaseous refrigerant flows, and a liquid pipe P2 that serves as a passage, through which a liquid refrigerant flows, which connect the outdoor unit 300 and the indoor unit 400. The gas pipe P1 and the liquid pipe P2 extend into the inside of the outdoor unit 300 and the indoor unit 400.

The outdoor unit 300 includes a compressor 310 configured to compress a refrigerant, an outdoor heat exchanger 320 configured to perform heat exchange between outdoor air and a refrigerant, a four-way valve 330 configured to selectively guide the refrigerant compressed in the compressor 310 to either the outdoor heat exchanger 320 or the indoor unit 400 depending on heating or cooling modes, an outdoor expansion valve 340 configured to decompress the refrigerant guided to the outdoor heat exchanger 320 in the heating mode, and an accumulator 350 configured to prevent the liquid refrigerant, which is not yet evaporated, from flowing into the compressor 310.

The compressor 310 may compress a low-pressure gaseous refrigerant to a high-pressure state by using a rotational power of a compressor motor that rotates by receiving electric energy from an external power source.

The four-way valve 330 guides the refrigerant compressed in the compressor 310 to the outdoor heat exchanger 320 during cooling, and guides the refrigerant compressed in the compressor 310 to the indoor unit 400 during heating.

The outdoor heat exchanger 320 condenses the refrigerant compressed by the compressor 310 during cooling, and evaporates the refrigerant decompressed by the indoor unit 400 during heating. The outdoor heat exchanger 320 may be applied with a heat exchanger 1 according to the present disclosure. In other words, the heat exchanger 1 includes a tube 10 through which the refrigerant flows, and a heat exchange fin 30 coupled to a surface of the tube. The tube 10 and the heat exchange fin 30 may be coupled by a filler 36. Hereinafter descriptions the same as those described above will be omitted.

In the heating mode, the outdoor expansion valve 340 may decompress the refrigerant and regulate an amount of refrigerant supplied to the outdoor heat exchanger 320 for sufficient heat exchanger in the outdoor heat exchanger 320. Particularly, the outdoor expansion valve 340 may decompress the refrigerant by utilizing the throttling action of the refrigerant, in which the pressure of the refrigerant decreases without heat exchange with the outside when the refrigerant passes through a narrow flow path.

The indoor unit 400 includes an indoor heat exchanger 410 configured to perform heat exchange between indoor air and refrigerant, and an indoor expansion valve 420 configured to decompress refrigerant supplied to the indoor heat exchanger 410 during cooling.

The indoor heat exchanger 410 may evaporate a low-pressure liquid refrigerant during cooling and condense a high-pressure gaseous refrigerant during heating. The heat exchanger 1 according to the present disclosure may be applied to the indoor heat exchanger 410. For convenience of description, a description that is the same as the above will be omitted.

The indoor expansion valve 420 may not only reduce the pressure of the refrigerant by using the throttling action, but also regulate the amount of refrigerant supplied to the outdoor heat exchanger 320 to allow sufficient heat exchange to occur in the indoor heat exchanger 410.

The refrigerant may exchange heat with the outside air while changing phase (compressing) from a gaseous state to a liquid state, or may exchange heat with the outside air while changing phase (expanding) from a liquid state to a gaseous state. When the refrigerant changes phase from a gaseous state to a liquid state, the heat exchanger 1 may be used as a condenser, and when the refrigerant changes phase from a liquid state to a gaseous state, the heat exchanger 1 may be used as an evaporator.

In the above, an example, in which the heat exchanger 1 according to one embodiment is applied to the air conditioner 200, has been described.

Next, the heat exchanger 1 according to the present disclosure will be described in more detail.

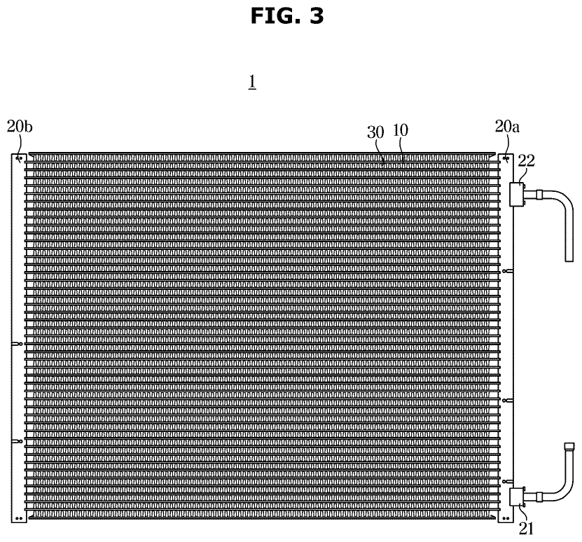

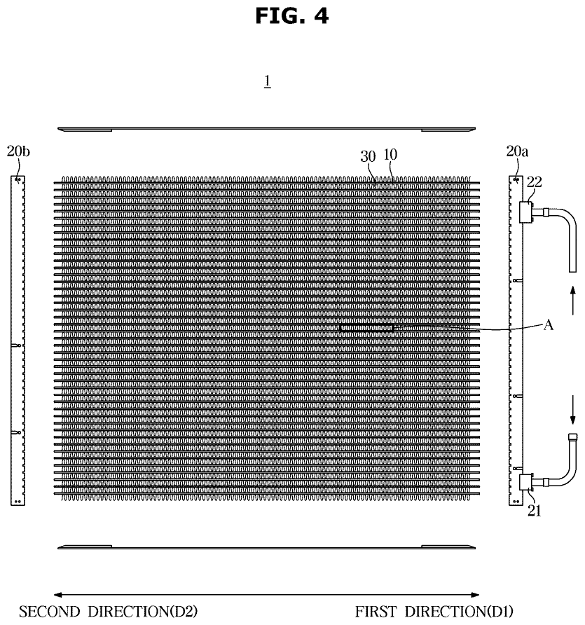

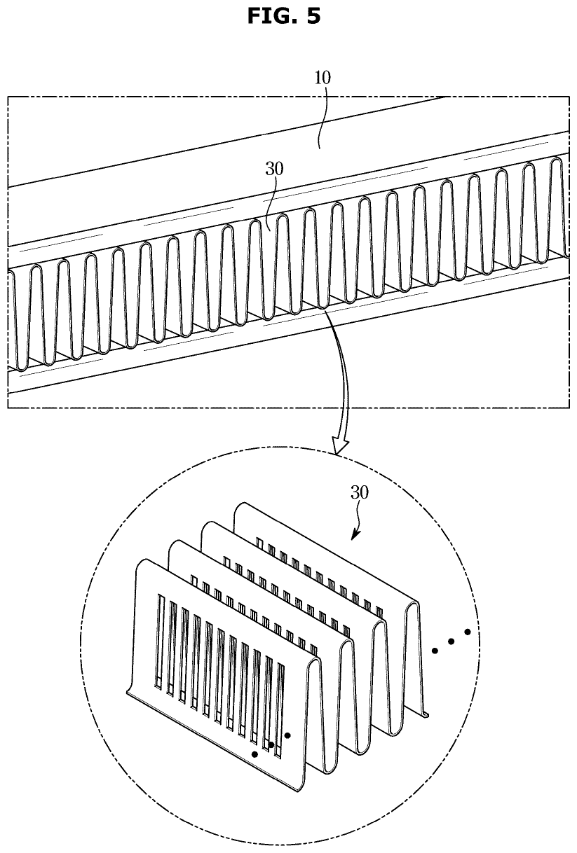

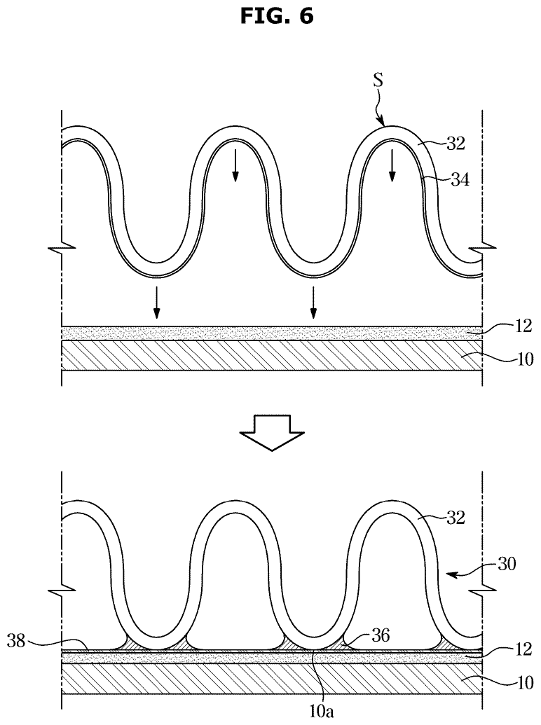

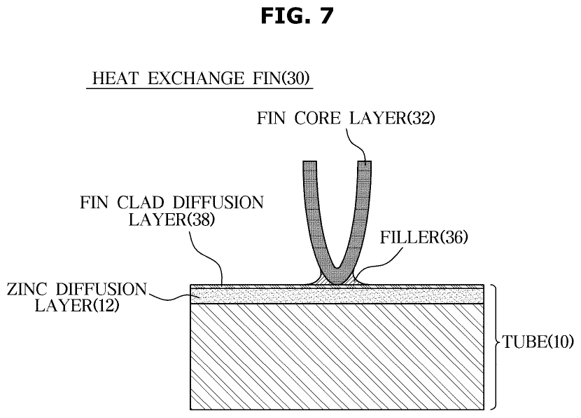

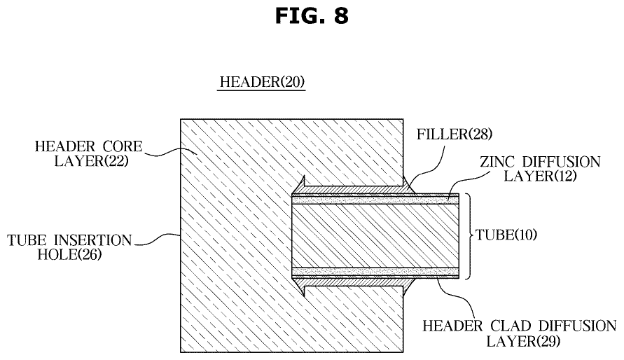

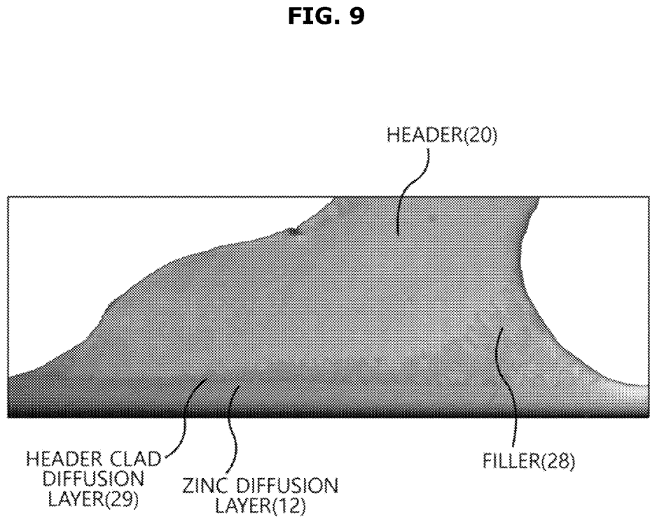

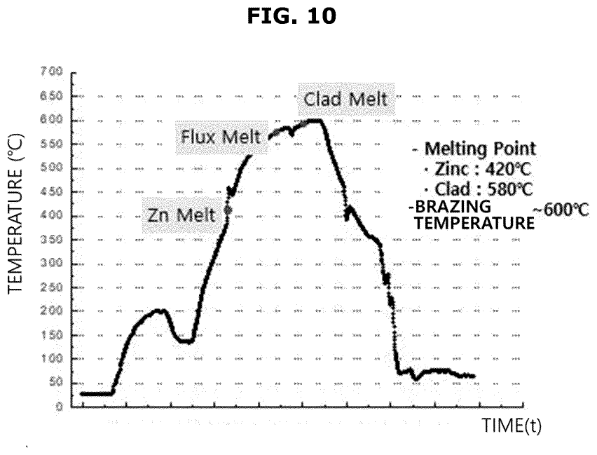

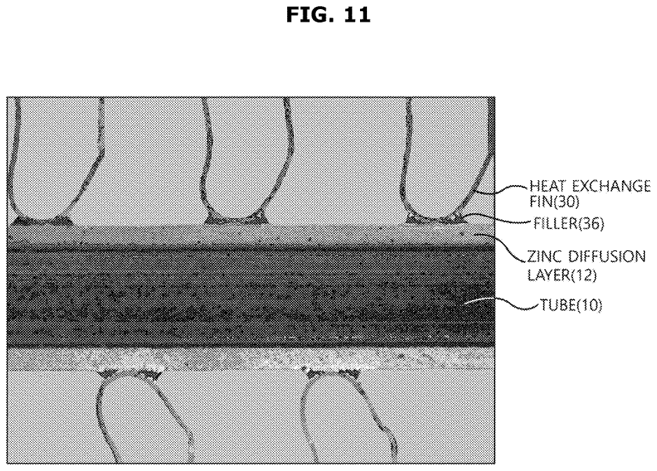

FIG. 3 is a view illustrating an exterior of a heat exchanger according to one embodiment, FIG. 4 is an exploded perspective view illustrating the heat exchanger according to one embodiment, FIG. 5 is an enlarged view of a portion A of FIG. 4, FIG. 6 is a view illustrating a tube and a heat exchange fin before and after brazing, FIG. 7 is a schematic diagram of an example of the heat exchanger in which the heat exchange fin and the tube are coupled according to one embodiment, FIG. 8 is a schematic diagram of an example in which a header and the tube are coupled according to one embodiment, FIG. 9 is a photograph illustrating a cross-section of a state in which the header and the tube are brazed according to one embodiment, FIG. 10 is a view illustrating heating temperatures over time during brazing according to one embodiment, and FIG. 11 is a photograph illustrating a cross-section of a state in which the tube and the heat exchange fin are brazed according to one embodiment.

The heat exchanger 1 according to one embodiment may include a plurality of tubes 10, headers 20a and 20b, and a plurality of heat exchange fins 30.

### [Tube]

Referring to FIG. 3, the plurality of tubes 10 may be arranged parallel to each other, and channels may be formed inside to allow a refrigerant corresponding to fluid to flow. In addition, the plurality of tubes 10 may be coupled to form a tube assembly.

The plurality of tubes 10 may be extruded or injection molded. Hereinafter for the convenience of description, a case in which the plurality of tubes 10 is extruded will be described as an example. According to one embodiment, a connecting member may be coupled to opposite ends of the plurality of tubes 10. The connecting member may be coupled to opposite ends of the plurality of tubes 10 to form a tube array. The connecting member may be a separate component from the plurality of tubes 10, but according to embodiments, the connecting member may be extruded and molded integrally with the plurality of tubes 10.

In addition, in order to improve corrosion resistance, the plurality of tubes 10 is subjected to a pretreatment to form a zinc diffusion layer 12 on the surface of the tube. That is, the pretreatment method may be performed by selecting any one of a zinc flux, a zinc powder coating method, or a zinc spray treatment method, and a zinc layer is formed accordingly.

### [Heat Exchange Fins]

Referring to FIG. 4, the heat exchange fins 30 may be interposed between the plurality of tubes 10 to allow a refrigerant, which flows along the channels formed inside the tubes 10, to efficiently exchange heat with the outside air. That is, the heat exchange fins 30 may be arranged so as to come into contact with the tubes 10 in a heat exchange space.

Referring to FIG. 5, the heat exchange fin 30 may be provided in a shape that is bent multiple times. Particularly, the heat exchange fin 30 may include a first inclined surface that slopes upward in a first direction and a second inclined surface that extends from the first inclined surface and slopes downward in the first direction. The first direction is defined as a direction in which the heat exchange fin 30 extends along a contact portion between the tube 10 and the heat exchange fin 30. The heat exchange fin 30 may be provided in a zigzag shape by coupling a plurality of first and second inclined surfaces. According to one embodiment, the heat exchange fin 30 may be formed in various shapes to increase a surface that comes into contact with the outside air, and may be installed to allow a portion, in which the first and second inclined surfaces are connected and bent, to come into contact with an inner surface of a contact portion 10a with the tube 10 to cause heat exchange.

According to FIG. 6, a fin material of the heat exchange fin 30 may be a brazing sheet-type fin material that may be soldered at high temperatures. The brazing sheet S may include a fin core layer 32 and a fin clad layer 34 formed on one or opposite surfaces of the fin core layer 32.

In a state in which the fin clad layer 34 is formed on one surface of the fin core layer 32, brazing welding may be performed as a clad surface of the fin clad layer 34 faces the tube 10 during brazing welding of the tube 10 and the heat exchange fin 30. During the brazing welding, the fin clad layer 34 may be melted to form a filler 36.

### [Header]

According to FIGS. 3 and 4, the header 20 may include a first header 20a and a second header 20b coupled to the outer side of the connecting member. The first header 20a may be coupled to the outer side of the tube 10 so as to face the first direction D1, and the second header 20b may be coupled to the outer side of the tube 10 so as to face the second direction D2. The first header 20a and the second header 20b may be arranged to be spaced apart from each other by a constant interval, and the plurality of tubes 10 may be arranged between the first header 20a and the second header 20b.

One end of the plurality of tubes 10 facing the first direction D1 may be connected to the first header 20a, and the other end of the plurality of tubes 10 facing the second direction D2 may be connected to the second header 20b. However, an arrangement structure of the header 20 and the plurality of tubes 10 is not limited to the above-described example.

The first header 20a may include an inlet header 21 and an outlet header 23. An inlet port, through which a refrigerant flows toward the plurality of tubes 10, may be formed in the inlet header 21, and an outlet port, through which a refrigerant flows out from the plurality of tubes, may be formed in the outlet header 23.

According to embodiments, the inlet header 21 may be provided in the second header 20b or the outlet header 23 may be provided in the second header 20b so as to allow the inlet header and outlet header to face different directions.

In addition, referring to FIG. 8, the header 20 is formed with a header core layer 22 forming a body and a tube insertion hole 26 for coupling the plurality of tubes 10.

### [Brazing of Tubes and Heat Exchange Fins]

Referring to FIG. 6, a portion, in which the plurality of heat exchange fins 30 and the plurality of tubes 10 come into contact, may be fixed by the brazing welding.

The brazing welding is a welding method that melts a filler metal at high temperatures, and the filler metal may have a lower melting point than an adhesive.

During the brazing welding process, high temperature heat may be applied to the fin clad layer 34, thereby melting the fin clad layer 34 to fix the contact portion 10a of the tube 10 and the heat exchange fin 30. Hereinafter a coupling portion, which is formed between the fin core layer 32 of the heat exchange fin 30 and the tube 10 by melting and spreading the fin clad layer 34 of the heat exchange fin 30, is defined as the filler 36.

That is, the filler 36 is formed between the fin core layer 32 and the tube 10 by melting the fin clad layer 34 of the heat exchange fin 30, and a composition of the filler 36 may be similar to that of the fin clad layer 34 or may have a slightly higher zinc content. In other words, an aluminum alloy material formed by melting the fin clad layer 34 may become the filler metal to form the filler. However, depending on embodiments, a potential value of the fin clad layer 34 and a potential value of the filler 36 may have a slight difference due to heat applied during the melting process, and it should be understood that other physical characteristics may also vary.

Referring to FIG. 7, when the heat exchange fin 30 is brazed to a pre-treated tube 10, a fin clad diffusion layer 38 is formed on the outermost surface of the tube, and the zinc diffusion layer 12 is formed as the heat exchange fin 30 is diffused into the inside of the tube 10, and a layer thickness at this time may be 100 μm or less.

### [Brazing of Tubes and Headers]

Referring to FIG. 8, a portion in which the tube 10 is inserted into the header 20 may be fixed by brazing welding.

The brazing welding is a welding method that melts filler metal at high temperatures, and the filler metal may have a lower melting point than an adhesive.

During the brazing welding process, high temperature heat may be applied to the header clad layer 24, thereby melting the header clad layer 24 and fixing the tube 10 to the header 20. In addition, a coupling portion, which is formed between the header 20 and the tube 10 as the header clad layer 24 of the header 20 is melted, is defined as a filler 28.

The filler 28 is formed by melting the header clad layer 24 of the header 20, and a composition of the filler 28 may be similar to that of the header clad layer 24 or may have a slightly higher zinc content. In other words, an aluminum alloy material formed by melting the header clad layer 24 may become filler metal to form the filler. However, depending on embodiments, a potential value of the header clad layer 24 and a potential value of the filler 28 may have a slight difference due to the heat applied during the melting process, and it should be understood that other physical characteristics may also vary.

Referring to FIG. 8, when the header 20 is brazed to a pre-treated tube 10, a header clad diffusion layer 29 is formed on the outermost surface of the tube, and the zinc diffusion layer 12 is formed as the header 20 is diffused into the inside of the tube 10, and a layer thickness at this time may be 100 μm or less.

### [Aluminum Alloys and Electrode Potential]

The purpose of the heat exchanger 1 according to the present disclosure is to improve corrosion resistance properties of the tube as alloy element components added to the tube material and fin material of the heat exchanger 1 are optimized to form a high electrode potential of the tube 10. In other words, by forming an electrode potential of the heat exchange fin 30 lower than that of the tube 10 or the header 20, sacrificial corrosion related to galvanic corrosion of the heat exchange fin 30 may be induced, and as a result, protection of the tube material may be induced.

When dissimilar metals come into contact, one of which accelerates the oxidation of the other and thus Galvanic corrosion occurs. This corrosion may be caused by the inherent difference in electrical potential between the metals. Particularly, when dissimilar metals are electrically connected and come into contact with an electrolyte solution, a corrosion cell is formed. The metal with the lower potential becomes the anode and promotes corrosion, while the metal with the higher potential becomes the cathode and protects the metal.

By utilizing the aforementioned corrosion action in reverse, corrosion of metal may be prevented, which is called cathodic protection. The heat exchanger 1 according to the present embodiment may prevent corrosion of the tube 10 by the cathodic protection method. More particularly, when an alloy is designed to lower the potential value of the fin core layer 32 of the heat exchange fin 30 and the header 20 compared to the tube 10 of the heat exchanger 1, the tube 10 may be protected.

In relation to the potential difference design, when the potential difference between the tube 10 and the fin core layer 32 is excessively large, corrosion of the heat exchange fin 30 may be accelerated, and it is difficult to prevent corrosion of the tube 10. When the potential difference between the tube 10 and the fin core layer 32 is excessively small, corrosion of the heat exchange fin 30 and the tube 10 may progress simultaneously, and it is difficult to protect the tube 10. Therefore, in order to prevent corrosion of the tube 10, it is required to control the corrosion potential formed between the tube 10 and the fin core layer 32 and between the tube 10 and the header 20 within a certain range when a galvanic couple is formed between the tube 10 and the fin core layer 32 and between the tube 10 and the header 20. As for the heat exchanger according to one embodiment, the tube 10 may have a potential value higher than that of the fin core layer 32 by 20 to 250 mV, and the fin core layer 32 may have a potential value lower than that of the fin clad layer 34 by 20 to 100 mV.

### [Aluminum Alloy Composition]

In the present disclosure, various substances may be added to each aluminum alloy material at various composition ratios to control the potential difference formed among the tube 10, the filler 36, and the fin core layer 32. Hereinafter the composition ratio of the aluminum alloy material will be described in detail.

In particular, the present disclosure is divided into alloy design for improving corrosion resistance of the tube, corrosion resistance between the tube and the heat exchange fin, and corrosion resistance between the tube and the header.

### (Tube Component)

First, the aluminum alloy material component of the tube 10 for the heat exchanger 1 according to one embodiment will be described.

The tube 10 according to the embodiment may include aluminum (Al) as a main component and may include other metal components, and may further include at least one selected from a group consisting of manganese (Mn), magnesium (Mg), zinc (Zn), and chromium (Cr).

In particular, it may be composed of a group of aluminum alloys selected from at least one of quinary, quaternary and ternary systems, such as Al—Mn—Mg—Zn—Cr, Al—Mn—Mg—Zn, Al—Mn—Mg—Cr, Al—Mn—Zn—Cr, Al—Mn—Mg, Al—Mn—Zn, Al—Mn—Cr.

These components may be added in an appropriate amount within a range of a purpose of improving the corrosion resistance of the tube 10 by forming the electrode potential of the tube 10 higher than that of the filler 36 and the heat exchange fin 30.

Particularly, the tube 10 may include 0.3 to 0.9% by weight of manganese (Mn), 0.05 to 0.3% by weight of magnesium (Mg), 0.05 to 0.3% by weight of zinc (Zn), and 0.05 to 0.3% by weight of chromium (Cr), and aluminum (Al) corresponding to the remaining weight %.

In particular, the electrode potential may be increased to some extent by excluding silicon (Si) compared to the conventional A3000 series alloy.

Hereinafter the reasons for controlling the content of each component included in the tube 10 are particularly described.

Manganese (Mn) improves corrosion resistance by dispersing impurities, and thus manganese (Mn) may be included in an amount of 0.3 wt % or more. When manganese (Mn) exceeds 0.9 wt %, the strength increases and productivity decreases, and thus the upper limit may be controlled to 0.9 wt % or less.

Additionally, magnesium (Mg) and zinc (Zn) are elements that improve corrosion resistance and are included in amounts of 0.05 wt % or more. However, when magnesium (Mg) and zinc (Zn) exceed 0.3 wt %, stress corrosion cracking may occur, and thus the upper limit may be controlled to 0.3 wt % or less.

When magnesium (Mg) and zinc (Zn) are included, grains are refined and fluidity of the material increases during extrusion, thereby increasing an extrusion speed of the tube 10. Accordingly, the extrusion speed may be increased by about 70% compared to the conventional A3000 series alloy.

In addition, chromium (Cr) is included in an amount of 0.05 wt % or more to reduce grain size. However, when chromium (Cr) exceeds 0.3 wt %, strength increases and productivity decreases, and thus the upper limit may be controlled to 0.3 wt % or less.

### (Components of Fin Core Layer and Fin Clad Layer)

Next, the aluminum alloy material component of the heat exchange fin 30 for the heat exchanger 1 according to one embodiment will be described in more detail.

The heat exchange fin 30 according to one embodiment may be a brazing sheet fin material that may be soldered at high temperatures. The brazing sheet may be formed by bonding the fin core layer 32 and the fin clad layer 34, and when the tube 10 and the brazing sheet are coupled by brazing welding, the fin clad layer 34 of the brazing sheet may be melted to form the filler 36 between the fin core layer 32 and the tube 10. Due to the influence of the fin clad layer 34 and the zinc diffusion layer 12, the filler 36 may have a somewhat higher zinc content than the fin clad layer 34. For this reason, the fin material hereinafter may be a concept including a core material forming the fin core layer 32 of the heat exchange fin 30 and a clad material forming the fin clad layer 34 of the heat exchange fin 30, and may also be a concept including a core material forming the fin core layer 32 of the heat exchange fin 30 and a filler material forming the filler 36 according to embodiments.

The fin core layer 32 and fin clad layer 34 of the heat exchange fin 30 may each be formed of aluminum material.

The heat exchange fin 30 may be formed of an aluminum alloy material containing silicon (Si), manganese (Mn), and zinc (Zn) based on an aluminum material. The components included in the aluminum alloy material may be added in a certain concentration range within a range intended for controlling the potential of the fin material. More particularly, contents of silicon (Si), manganese (Mn), and zinc (Zn) included in the aluminum alloy material forming the fin clad layer 34 and the fin core layer 32 may be controlled to allow the fin clad layer 34 to form a higher potential than the fin core layer 32.

According to one embodiment, the fin core layer 32 may include 0.5 to 1.0% by weight of silicon (Si), 1.3 to 1.8% by weight of manganese (Mn), 1.0 to 2.0% by weight of zinc (Zn), and remainder being aluminum (Al).

Additionally, the fin clad layer 34 may include 6.0 to 8.2% by weight of silicon (Si), 0.5 to 1.5% by weight of zinc (Zn), and remainder being aluminum (Al).

Hereinafter the reasons for controlling the content of each component included in the heat exchange fins 30, 32, and 34 are particularly described.

First, silicon (Si) of the fin core layer 32 is an impurity that is inevitably included during the process of manufacturing the alloy, but in the case of the fin clad layer 34, silicon (Si) is added to lower a melting point. However, when silicon (Si) is added in large amounts, erosion of the base material occurs, and thus silicon (Si) may be limited to 6 to 8.2 wt %.

Manganese (Mn) is used to improve the strength of the heat exchange fin 30 and to prevent the heat exchange fin 30 coupled to the tube 10 from being sagged in the direction of gravity.

In addition, zinc (Zn) is added for controlling the potential value. A potential value of the fin clad layer 34 is formed higher than that of the fin core layer 32, and a potential value of the fin core layer 32 is formed lower than that of the fin clad layer 34, thereby preventing corrosion of the tube 10.

According to the experimental results of an example described below, the potential values of the tube 10, the fin clad diffusion layer 38, and the fin core layer 32 are −683 mV, −808 to −780 V, and −863 mV, respectively. Because the potential values of the fin clad diffusion layer 38 and the fin core layer 32 are lower than that of the tube 10, corrosion of the tube 10 may be prevented.

### (Header Core Layer and Header Clad Layer Components)

Next, the aluminum alloy material component of the header 20 according to one embodiment will be described in detail.

First, the header core layer 22 may use A3003 material.

The header clad layer 24 may include 6.8 to 11.0% by weight of silicon (Si), 0.4% or less by weight of iron (Fe) (excluding 0), 0.3% or less by weight of copper (Cu) (excluding 0), and remainder being aluminum (Al). Because iron (Fe) and copper (Cu) are diffused into the zinc diffusion layer 12 of the tube during brazing, and act to increase the potential value of the zinc diffusion layer 12. Accordingly, iron (Fe) and copper (Cu) may be limited to the above range.

In addition, because the zinc diffusion layer 12 of the tube 10 has a lower potential and a higher corrosion rate when the header clad layer 24 includes zinc (Zn), the header clad layer 24 may not include zinc (Zn) to prevent this.

### [Behavior Between Tube and Heat Exchange Fin and Between Header and Tube During Brazing]

According to FIGS. 10 and 11, a temperature of brazing is 600° C., a melting point of zinc (Zn) is 420° C., and a melting point of the clad layers 24 and 34 is 580° C., which is higher than that of zinc (Zn), and thus zinc (Zn) is diffused into the tube 10 before the melting point of the clad layers 24 and 34 is reached at an initial stage of brazing. At this time, a thickness of the zinc diffusion layer 12 on the surface of the tube 10 is formed to a maximum of 100 μm.

In addition, in a process of heating up to the maximum temperature of brazing over time, the clad layers 24 and 34 are melted, components of the clad layers 24 and 34 are diffused into the inside of the tube, and then solidifies to act as the fillers 26 and 28 to connect the tube 10 to the header 20 and the heat exchange fin 30 to the tube 10.

According to FIG. 11, the zinc diffusion layer 12 is clearly visible on the surface of the tube 10, and the filler 36 is visible around the left and right sides where the heat exchange fin 30 and the tube 10 come into contact.

### [Experimental Results]

An aluminum alloy having the aforementioned aluminum alloy composition was subjected to casting, heat treatment, high-temperature rolling, room-temperature rolling, and annealing to manufacture an evaluation sample, and the corrosion resistance of the sample was evaluated through a Copper Accelerated Acetic Acid Salt Spray test (CASS) test.

The CASS test was performed by spraying a solution containing 5% NaCl and CuCl2 at a pH of 3.1 to 3.3 at a rate of 1.0 to 2.0 ml/h for 24 hours.

Additionally, the potential value measurement was performed using the corrosion potential value simulation method.

Table 1 below shows the potential values according to the composition of the tube.

TABLE 1

| | | Potential |
|---|---|---|
| Tube classification | Composition | value [mV] |
| Comparative example tube material 1 | 0.35Mn | −706 |
| Example tube material 1 | 0.7Mn—0.15Cr | −683 |
| Example tube material 2 | 1.0Mn | −670 |
| Example tube material 3 | 0.5Cu—0.2Mn | −692 |

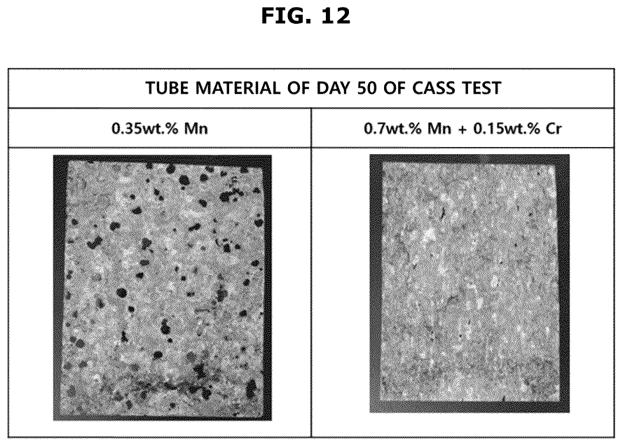

In particular, referring to FIG. 12, it was confirmed that Comparative example tube material 1 containing only 0.35 Mn content was penetrated after 50 days in the CASS test, but Example tube material 1 having a high Mn content and Cr content was good even after 50 days in the CASS test.

The composition and potential values of the fin clad layer 34, the fin core layer 32, the header clad layer 24, the header core layer 22, the fillers 28 and 36, and the zinc diffusion layer 12 used in the heat exchanger are shown in Table 2 below

TABLE 2

| | | Potential |
|---|---|---|
| Classification | | value (mV) |
| Fin clad layer | Comparative example Fin clad | −805 |
| | Material 1 | |
| | (7.5Si—0Zn) | |
| | Example fin clad material 1 | −810 |
| | (7.5Si—1.0Zn) | |
| Fin core layer | Example fin core material 1 | −863 |
| | (1.6Mn—1.5Zn) | |
| Header clad | Comparative example Header Clad | −785 |
| layer | Material 1 | |
| | (10Si—1.0Zn) | |
| | Example Header Clad Material 1 | −748 |
| | (10Si—0Zn) | |
| Header core | Comparative example Header Core | −720 |
| layer | Material 1 | |
| | (1.1Mn—0.44Cu) | |
| | Example header core material 1 | −706 |
| | (1.5Mn—0.3Cu) | |

Table 3 below shows the CASS test results of heat exchangers manufactured according to Example and Comparative example materials of the tube, the fin clad layer, the fin core layer, the header clad layer, the header core layer, and the filler, and zinc diffusion layer described above.

TABLE 3

| | | Comparative | |
|---|---|---|---|
| Classification | | example | Example |
| Tube composition | | 0.35Mn | 0.7Mn—0.15Cr |
| Tube potential value [mV] | | −706 | −683 |
| Filler 36 | Composition | 7.5Si—0Zn | 7.5Si—1.0Zn |
| | Potential | −805 | −810 |
| | value [mV] | | |
| Fin core layer | Composition | 1.6Mn—1.5Zn | 1.6Mn—1.5Zn |
| | Potential | −863 | −863 |
| | value [mV] | | |
| Filler 28 | Composition | 10Si—1.0Zn | 10Si—0Zn |
| | Potential | −785 | −748 |
| | value [mV] | | |
| Header core | Composition | 1.1Mn—0.44Cu | 1.5Mn—0.3Cu |
| layer | Potential | −720 | −706 |
| | value [mV] | | |
| Fin clad | Composition | — | — |
| diffusion layer | Potential | −800~−785 | −805~−780 |
| | value [mV] | | |
| Header clad | Composition | — | — |
| diffusion layer | Potential | −780~−760 | −740~−720 |
| | value [mV] | | |
| Zinc | Composition | — | — |
| diffusion layer | Potential | −780~−730 | −785~−735 |
| | value [mV] | | |

| CASS exam results | Refrigerant leak | Refrigerant leak |
|---|---|---|
| | on day 47/48 | on day 86/90 |

In the case of Table 3 above, it can be seen that the potential values of the heat exchanger 1 according to one embodiment have the order of tube >zinc diffusion layer >fin clad diffusion layer >filler >fin core layer and the order of tube >zinc diffusion layer >header clad diffusion layer >filler >header core layer. When corrosion of the fin core layer 32 progresses, a galvanic couple may be formed between the fin core layer 32 and the fin clad diffusion layer 38 or the fin core layer 32 and the tube 10. In this case, electrons (e-) may move from the fin core layer 32 toward the fin clad diffusion layer 38 or from the fin core layer 32 toward the tube 10, and as a result, corrosion of the tube may be prevented through sacrificial corrosion of the fin core layer 32 and the fin clad diffusion layer 38. When the sacrificial corrosion of the fin core layer 32 progresses to a certain extent, corrosion of the fin clad diffusion layer 38 may progress and corrosion of the zinc diffusion layer 12 may progress. When corrosion of the fin clad diffusion layer 38 and the surface of the tube progresses, electrons (e-) may move toward the tube 10. In this way, corrosion of the fin core layer 32, the filler 36, the fin clad diffusion layer 38, and the zinc diffusion layer 12 progresses sequentially, and thus the tube material and the header material may be protected.

A heat exchanger according to one embodiment may include a header 20 configured to supply a refrigerant to tube 10,

the tube 10 through which the refrigerant flows, a heat exchange fin 30 coupled to a surface of the tube 10, and a filler 36 coupling the tube 10 and the heat exchange fin 30. The header 20, the tube 10, the heat exchange fin 30 and the filler 36 may include an aluminum alloy. A fin clad diffusion layer 38 and a zinc diffusion layer 12 may be formed on at least one surface of the tube 10. The tube 10 may have a potential value higher than that of the fin core layer 32 by 20 to 250 mV, and the fin core layer 32 may have a potential value lower than that of the fin clad diffusion layer 38 by 20 to 100 mV. By having this potential sequence, corrosion of the tube may be prevented.

The heat exchanger may include a filler 28 coupling the tube 10 and the header 20. A header clad diffusion layer 29 and a zinc diffusion layer 12 may be formed on at least one surface of the tube 10. The tube 10 may have a potential value higher than that of the header core layer 22 by 20 to 250 mV. The header core layer 22 may have a potential value lower than that of the header clad diffusion layer 29 by 20 to 100 mV. By having this potential sequence, corrosion of the tube may be prevented.

The tube may include at least one selected from a group consisting of Al—Mn—Mg—Zn—Cr, Al—Mn—Mg—Zn, Al—Mn—Mg—Cr, Al—Mn—Zn—Cr, Al—Mn—Mg, Al—Mn—Zn, and Al—Mn—Cr.

The tube 10 may include 0.3 to 0.9% by weight of manganese (Mn), 0.05 to 0.3% by weight of magnesium (Mg), 0.05 to 0.3% by weight of zinc (Zn), and 0.05 to 0.3% by weight of chromium (Cr), and remainder being aluminum (Al). Accordingly, corrosion resistance may be improved and grains may be refined.

The zinc diffusion layer 12 may be formed as a zinc layer, which is formed by at least one method selected from among zinc flux, zinc powder application, and zinc spraying, is diffused into an inside of the tube 10 during brazing welding of the heat exchange fin 30 and the tube 10.

The filler 36 may be formed by melting the fin clad layer 34 during brazing welding of the heat exchange fin 30 and the tube 10.

The fin clad layer 34 may include 6.0 to 8.2% by weight of silicon (Si), 0.5 to 1.5% by weight of zinc (Zn), and remainder being aluminum (Al).

The fin core layer 32 may include 0.5 to 1.0% by weight of silicon (Si), 1.3 to 1.8% by weight of manganese (Mn), 1.0 to 2.0% by weight of zinc (Zn), and remainder being aluminum (Al).

The filler 28 may be formed by melting the header clad layer 24 during brazing welding of the header 20 and the tube 10.

The header clad layer 24 may include 6.8 to 11.0% by weight of silicon (Si), 0.4% or less by weight of iron (Fe) (excluding 0), 0.3% or less by weight of copper (excluding 0), and remainder being aluminum (Al), and may not include zinc.

An air conditioner according to one embodiment may include a compressor 310, an indoor heat exchanger 410, an outdoor heat exchanger 320, and an expansion valve 340.

At least one of the indoor heat exchanger 410 and the outdoor heat exchanger 320 may include
a header 20 configured to supply a refrigerant to tube 10, the tube 10 through which the refrigerant flows,
a heat exchange fin 30 coupled to a surface of the tube, and a filler 36 coupling the tube and the heat exchange fin.

The header 20, the tube 10, the heat exchange fin 30 and the filler 36 may include an aluminum alloy. A fin clad diffusion layer 38 and a zinc diffusion layer 12 may be formed on at least one surface of the tube 10. The tube 10 may have a potential value higher than that of the fin core layer 32 by 20 to 250 mV, and the fin core layer 32 may have a potential value lower than that of the fin clad diffusion layer 38 by 20 to 100 mV.

The air conditioner may include a filler 28 coupling the tube 10 and the header 20. A header clad diffusion layer 29 and a zinc diffusion layer 12 may be formed on at least one surface of the tube 10. The tube 10 may have a potential value higher than that of the header core layer 22 by 20 to 250 mV. The header core layer 22 may have a potential value lower than that of the header clad diffusion layer 29 by 20 to 100 mV.

The tube 10 may include at least one selected from a group consisting of Al—Mn—Mg—Zn—Cr, Al—Mn—Mg—Zn, Al—Mn—Mg—Cr, Al—Mn—Zn—Cr, Al—Mn—Mg, Al—Mn—Zn, and Al—Mn—Cr.

The tube 10 may include 0.3 to 0.9% by weight of manganese (Mn), 0.05 to 0.3% by weight of magnesium (Mg), 0.05 to 0.3% by weight of zinc (Zn), and 0.05 to 0.3% by weight of chromium (Cr), and remainder being aluminum (Al).

The zinc diffusion layer 12 may be formed as a zinc layer is formed by at least one method selected from among zinc flux, zinc powder application, and zinc spraying, and is diffused into an inside of the tube 10 during brazing welding of the heat exchange fin 30 and the tube 10.

The filler 36 may be formed by melting the fin clad layer 34 during brazing welding of the heat exchange fin 30 and the tube 10.

The fin clad layer 34 may include 6.0 to 8.2% by weight of silicon (Si), 0.5 to 1.5% by weight of zinc (Zn), and remainder being aluminum (Al).

The fin core layer 32 may include 0.5 to 1.0% by weight of silicon (Si), 1.3 to 1.8% by weight of manganese (Mn), 1.0 to 2.0% by weight of zinc (Zn), and remainder being aluminum (Al).

The filler 28 may be formed by melting the header clad layer 24 during brazing welding of the header 20 and the tube 10.

The header clad layer 24 may include 6.8 to 11.0% by weight of silicon (Si), 0.4% or less by weight of iron (Fe) (excluding 0), 0.3% or less by weight of copper (Cu) (excluding 0), and remainder being aluminum (Al), and may not include zinc.

Although the embodiments of the invention disclosed above have been illustrated and described, the disclosed invention is not limited to the specific embodiments described above, and various modifications may be implemented by a person having ordinary skill in the art to which the disclosed invention pertains without departing from the gist claimed in the claims.

### EXPLANATION OF REFERENCE

1: Heat exchanger
10: Tube
12: Zinc diffusion layer
20a and 20b: Header
22: Header core layer
24: Header clad layer
29: Header clad diffusion layer
30: Heat exchange fin
32: Fin core layer
34: Fin clad layer
28 and 36: Filler
38: Fin clad diffusion layer
200: Air conditioner
300: Outdoor unit
400: Indoor unit

1. A heat exchanger comprising:
a header configured to supply a refrigerant to a tube through which the refrigerant flows;
a heat exchange fin to be coupled to a surface of the tube; and
a filler to couple the tube and the heat exchange fin,
wherein the header, the tube, the heat exchange fin and the filler comprise an aluminum alloy,
wherein a fin clad diffusion layer and a zinc diffusion layer are formed on at least one surface of the tube,
wherein the tube has a potential value higher than that of a fin core layer by 20 to 250 mV,
wherein the fin core layer has a potential value lower than that of the fin clad diffusion layer by 20 to 100 mV.

2. The heat exchanger of claim 1, further comprising:
an additional filler coupling the tube and the header,
wherein a header clad diffusion layer and a zinc diffusion layer are formed on at least one surface of the tube,
wherein the tube has a potential value higher than that of a header core layer by 20 to 250 mV,
wherein the header core layer has a potential value lower than that of the header clad diffusion layer by 20 to 100 mV.

3. The heat exchanger of claim 1, wherein
the tube comprises at least one selected from a group consisting of Al—Mn—Mg—Zn—Cr, Al—Mn—Mg—Zn, Al—Mn—Mg—Cr, Al—Mn—Zn—Cr, Al—Mn—Mg, Al—Mn—Zn, and Al—Mn—Cr.

4. The heat exchanger of claim 3, wherein
the tube comprises 0.3 to 0.9% by weight of manganese (Mn), 0.05 to 0.3% by weight of magnesium (Mg), 0.05 to 0.3% by weight of zinc (Zn), and 0.05 to 0.3% by weight of chromium (Cr), and remainder being aluminum (Al).

5. The heat exchanger of claim 1, wherein
the zinc diffusion layer is formed as a zinc layer, which is formed by at least one method selected from among zinc flux, zinc powder application, and zinc spraying, is diffused into an inside of the tube during brazing welding of the heat exchange fin and the tube.

6. The heat exchanger of claim 1, wherein
the filler is formed by melting a fin clad layer during brazing welding of the heat exchange fin and the tube.

7. The heat exchanger of claim 6, wherein
the fin clad layer comprises 6.0 to 8.2% by weight of silicon (Si), 0.5 to 1.5% by weight of zinc (Zn), and remainder being aluminum (Al).

8. The heat exchanger of claim 1, wherein
the fin core layer comprises 0.5 to 1.0% by weight of silicon (Si), 1.3 to 1.8% by weight of manganese (Mn), 1.0 to 2.0% by weight of zinc (Zn), and remainder being aluminum (Al).

9. The heat exchanger of claim 2, wherein
the additional filler is formed by melting a header clad layer during brazing welding of the header and the tube.

10. The heat exchanger of claim 9, wherein
the header clad layer comprises 6.8 to 11.0% by weight of silicon (Si), 0.4% or less by weight of iron (Fe) (excluding 0), 0.3% or less by weight of copper (Cu) (excluding 0), and remainder being aluminum (Al), and does not comprise zinc.

11. An air conditioner comprising
a compressor;
an indoor heat exchanger;
an outdoor heat exchanger; and
an expansion valve,
wherein at least one of the indoor heat exchanger and the outdoor heat exchanger comprises:
a header configured to supply a refrigerant to a tube through which the refrigerant flows;
a heat exchange fin coupled to a surface of the tube; and
a filler coupling the tube and the heat exchange fin,
wherein the header, the tube, the heat exchange fin and the filler comprise an aluminum alloy,
wherein a fin clad diffusion layer and a zinc diffusion layer are formed on at least one surface of the tube,
wherein the tube has a potential value higher than that of a fin core layer by 20 to 250 mV,
wherein the fin core layer has a potential value lower than that of the fin clad diffusion layer by 20 to 100 mV.

12. The air conditioner of claim 11,
wherein an additional filler couples the tube and the header,
wherein a header clad diffusion layer and a zinc diffusion layer are formed on at least one surface of the tube,
wherein the tube has a potential value higher than that of a header core layer by 20 to 250 mV,
wherein the header core layer has a potential value lower than that of the header clad diffusion layer by 20 to 100 mV.

13. The air conditioner of claim 11, wherein
the tube comprises 0.3 to 0.9% by weight of manganese (Mn), 0.05 to 0.3% by weight of magnesium (Mg), 0.05 to 0.3% by weight of zinc (Zn), and 0.05 to 0.3% by weight of chromium (Cr), and remainder being aluminum (Al).

14. The air conditioner of claim 11, wherein
a fin clad layer comprises 6.0 to 8.2% by weight of silicon (Si), 0.5 to 1.5% by weight of zinc (Zn), and remainder being aluminum (Al).

15. The air conditioner of claim 11, wherein
the fin core layer comprises 0.5 to 1.0% by weight of silicon (Si), 1.3 to 1.8% by weight of manganese (Mn), 1.0 to 2.0% by weight of zinc (Zn), and remainder being aluminum (Al),
wherein a header clad layer comprises 6.8 to 11.0% by weight of silicon (Si), 0.4% or less by weight of iron (Fe) (excluding 0), 0.3% or less by weight of copper (Cu) (excluding 0), and remainder being aluminum (Al), and does not comprise zinc.
